(19) United States
(12) Patent Application Publication
(10) Pub. No.: US 2024/0256622 A1
(43) Pub. Date: Aug. 1, 2024

(54) GENERATING A SEMANTIC SEARCH ENGINE RESULTS PAGE

(71) Applicant: Microsoft Technology Licensing, LLC, Redmond, WA (US)

(72) Inventors: Bradley Moore ABRAMS, Palo Alto, CA (US); Xia SONG, Redmond, WA (US); Baljinder Pal RAYIT, Redmond, WA (US); Elbio Renato Torres ABIB, Bellevue, WA (US)

(73) Assignee: Microsoft Technology Licensing, LLC, Redmond, WA (US)

(21) Appl. No.: 18/217,376

(22) Filed: Jun. 30, 2023

Related U.S. Application Data
(60) Provisional application No. 63/442,720, filed on Feb. 1, 2023.

(51) Int. Cl. G06F 16/9538; G06F 40/30

(52) U.S. Cl. CPC G06F 16/9538; G06F 40/30

(57) ABSTRACT

The present disclosure relates to generating semantic search engine results. Aspects of the present disclosure retrieve relevant information from a search engine based on user's search query. The query can be a classic search query (keyword or short phrase) or a conversational query (e.g., a chat messages between users and/or chatbots), a query based upon an email or other type of message, or a query generate based upon a content item (e.g., a webpage, image, video, document, etc.). Aspects of the disclosure leverage a large language model (LLM), such as, for example, a generative model, to summarizes the content according to the intent detected from the query. In some cases, aspects of the present disclosure may generate a direct answer to the query and provide relevant references to support the information.

### CROSS-REFERENCE TO RELATED APPLICATION

This application claims priority to U.S. Provisional Application No. 63/442,720, titled “GENERATING A SEMANTIC SEARCH ENGINE RESULTS PAGE,” filed on Feb. 1, 2023, the entire disclosure of which is hereby incorporated by reference in its entirety.

### BACKGROUND

Classical search engines typically only retrieve and rank relevant content based on the user's query, without providing additional information or analysis. Without additional information, users are required to navigate multiple results to determine information relevant to their query. It is with respect to these and other general considerations that embodiments have been described. Also, although relatively specific problems have been discussed, it should be understood that the embodiments should not be limited to solving the specific problems identified in the background.

### SUMMARY

Aspects of the present disclosure relate to systems and methods which provide a sematic search engine that is capable of performing functions beyond the capabilities of a classical search engine, such as, for example, summarizing and generating answers to queries, as well as providing a brief overview of the main facts, aspects or other disambiguation related to the query. Aspects of the disclosure relate to organizing and summarizing information from a retrieval-based search engine into a semantically meaningful format, so the information is more comprehensible and navigable for search engine users.

This Summary is provided to introduce a selection of concepts in a simplified form that are further described below in the Detailed Description. This summary is not intended to identify key features or essential features of the claimed subject matter, nor is it intended to be used to limit the scope of the claimed subject matter. Additional aspects, features, and/or advantages of examples will be set forth in part in the following description and, in part, will be apparent from the description, or may be learned by practice of the disclosure.

### BRIEF DESCRIPTION OF THE DRAWINGS

Non-limiting and non-exhaustive examples are described with reference to the following Figures.

FIG. 1 depicts an exemplary system that includes a sematic search engine.

FIG. 2 is a block diagram illustrating an exemplary method for generating semantic search engine results.

FIG. 3 is a block diagram illustrating a method for generating prompts for a machine learning model that is leveraged by a semantic search engine.

FIG. 4 provides an exemplary user interface depicting a summary of information generated by a sematic search engine.

FIGS. 5A and 5B illustrate overviews of an example generative machine learning model that may be used according to aspects described herein

FIG. 6 illustrates a block diagram illustrating example physical components of a computing device with which aspects of the disclosure may be practiced.

FIG. 7 illustrates a simplified block diagrams of a computing device with which aspects of the present disclosure may be practiced.

FIG. 8 is a simplified block diagram of a distributed computing system in which aspects of the present disclosure may be practiced.

### DETAILED DESCRIPTION

In the following detailed description, references are made to the accompanying drawings that form a part hereof, and in which are shown by way of illustrations specific embodiments or examples. These aspects may be combined, other aspects may be utilized, and structural changes may be made without departing from the present disclosure. Embodiments may be practiced as methods, systems, or devices. Accordingly, embodiments may take the form of a hardware implementation, an entirely software implementation, or an implementation combining software and hardware aspects. The following detailed description is therefore not to be taken in a limiting sense, and the scope of the present disclosure is defined by the appended claims and their equivalents.

Aspects of the present disclosure relate to organizing, synthesizing, and summarizing information from a classical retrieval-based search engine into a semantically meaningful format, so that the results are more comprehensible and navigable for users. That is, aspects disclosed herein relate to synthesizing traditional search information in a way that satisfies an intent associated with a received query. As part of the synthetization, aspects of the disclosure may gather additional information from various different data sources, such as local document stores, third-party platforms, applications, and the like in order to address the query intent. Aspects of the disclosure may create a summary that provides an overview of the information initial search results, and then creates disambiguated subsections about different aspects of the original search query based on its intent. These subsections use citation links to attribute the summarized information to their sources to provide credibility. In some examples, rather than creating a summary, aspect disclosed herein may provide an entire document, webpage, dataset, etc. in addition to a summary or in alternative of providing a summary. Among other benefits, aspects of the present disclosure help users quickly find and understand the information they are looking for by providing a curated and structured view of the search engine results page (SERP).

Aspects of the present disclosure retrieve relevant information from a search engine based on user's search query. The query can be a classic search query (keyword or short phrase) or a conversational query (e.g., a chat messages between users and/or chatbots), a query based upon an email or other type of message, or a query generate based upon a content item (e.g., a webpage, image, video, document, etc.). Aspects of the disclosure leverage a large language model (LLM), such as, for example, a generative model, to summarizes the content according to the intent detected from the query. In some cases, aspects of the present disclosure may generate a direct answer to the query and provide relevant references to support the information. Additionally, aspects disclosed herein provide a brief overview of the main facts or aspects related to the user's query, using information from reference documents. The model has access to data such as the date and location of the query, as well as the top web results (e.g., top five result, top five results, top ten results, etc.) and surrounding information and/or contextual information for each result.

Among other technical benefits, aspects of the present disclosure provide capabilities beyond that of a classical search engine by summarizing and generating answers to queries, as well as providing a brief overview of the main facts, aspects or other disambiguation related to the query. Classical search engines typically only retrieve and rank relevant content based on the user's query, without providing additional information or analysis. Our system achieves the new capabilities by leveraging large language models. One of skill in the art will appreciate other technical benefits provided by the aspects disclosed herein.

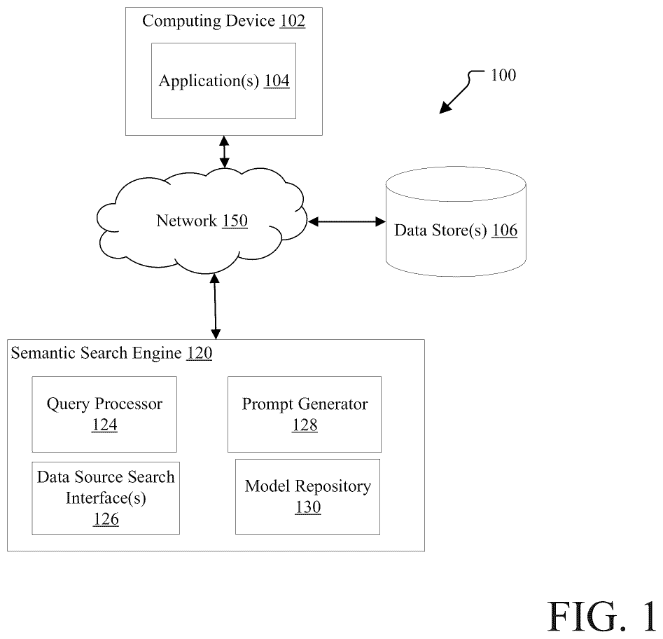

FIG. 1 depicts an exemplary system 100 that includes a semantic search engine 120. System 100 includes a computing device 102, a semantic search engine 120, and one or more data store(s) 106 which communicate via a network 115. Computing device 102 may be any of a variety of computing devices, including, but not limited to, a mobile computing device, a laptop computing device, a tablet computing device, a desktop computing device, and/or a virtual reality computing device. Computing device 102 may be configured to execute one or more application(s) 104 and/or services and/or manage hardware resources (e.g., processors, memory, etc.), which may be utilized by users of the computing device 102. The application(s) 104 may be a native application or a web-based application. For example, the application(s) 104 may be a web browser, a digital personal assistant, a file browser, etc. The application(s) 104 may be used for communication across the network 150 to submit queries to the semantic search engine 120. While not shown, in alternate examples an instance of the semantic search engine 120 may reside locally on the computing device 102.

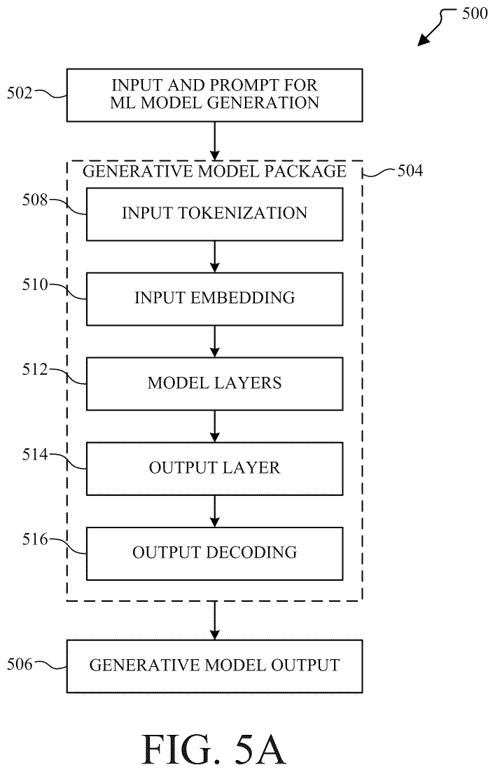

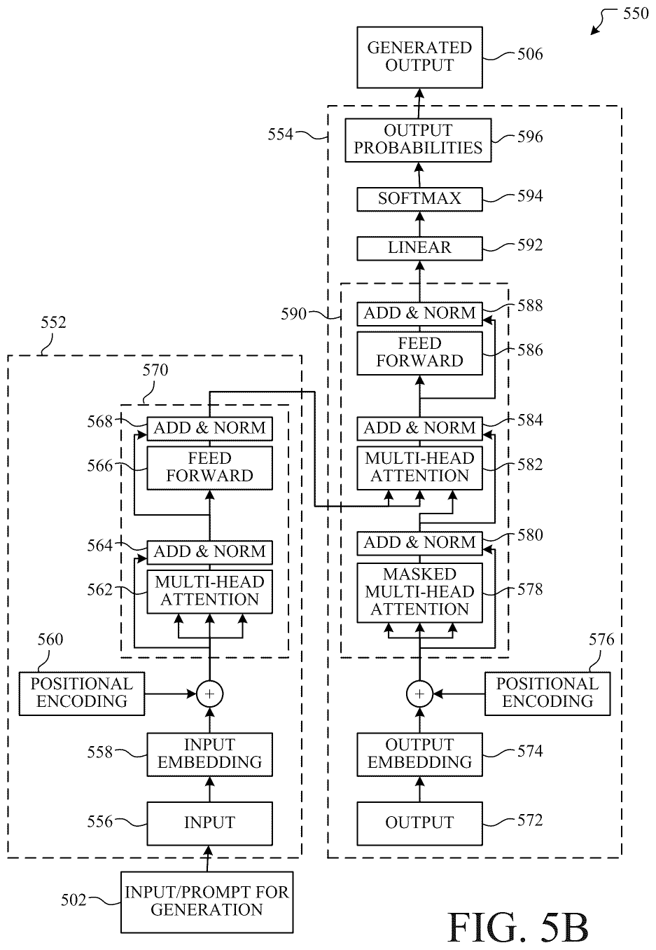

In examples, the semantic search engine 120 receives a query from the computing device 102 and processes the query using query processor 124. In one example, the query may be a query for information on a network, such as the Internet. For example, the query can be a query provided to search engine. In other aspects, the query may be generated based upon a user intent derived from a user interaction (e.g., a user interacting with a chatbot, a user selecting a web page or other type of content) and/or from other content items (e.g., emails, documents, web pages, presentations, etc.). In still further examples, aspects of the present disclosure may generate additional queries related to the received query (e.g., disambiguation queries, alternate queries, etc.). In examples, the additional queries may be generated by an associated search engine, by a machine learning model, such as one or more of the models that are part of the model repository 130, etc. Query processor 124, in examples, processes the query (or queries) and generates an initial set of results in response to receiving the query. For example, the query processor may be a search engine that will generate a set of web search results based upon the received query. The query and the set of search results may be provided to a machine learning model to process the initial sets of results. For example, one or more machine learning (ML) models may be stored in model repository 130. The query processor 124 may provide the results to a model from the repository based upon the type of content retrieved in the search results. In one example, a generative large language model (LLM) may be used to process the search results generated by the query processor 124. A generative model (also generally referred to herein as a type of ML model) used according to aspects described herein may generate any of a variety of output types (and may thus be a multimodal generative model, in some examples) and may be a generative transformer model and/or a large language model (LLM), a generative image model, in some examples. Example ML models include, but are not limited to, Generative Pre-trained Transformer 3 (GPT-3), BigScience BLOOM (Large Open-science Open-access Multilingual Language Model), DALL-E, DALL-E 2, Stable Diffusion, or Jukebox. Additional examples of such aspects are discussed below with respect to the generative ML model illustrated in FIGS. 5A-5B. The generative LLM may process the search results and determine whether the initial set of results satisfies an intent or task associated with the query. If not, the generative LLM that is part of the semantic search engine 120 may generate additional searches for information that can be used to satisfy the intent and or task associated with the query. The generated searches may be provided to the query processor 124 and/or the data source search interface 126 in order to query one or more additional data sources based upon the generated queries. In examples, different types of data sources 106 may be searched, e.g., web pages, application data stores, document stores, databases, etc. The data source search interface 126 helps process the queries across the different data sources. For example, the data source search interface 126 may include APIs or libraries that can be leveraged to access data from different data sources (e.g., weather information, stock information, third-party databases, etc.) to gather additional information relate to the query and/or related to an intent determined based upon the query and/or user interaction.

Upon retrieving data required to answer the query intent and/or task, the machine learning model employed by the semantic search engine 120 may summarize the content found in the results. As will be discussed further below, the machine learning model may be prompted to generate the summary in a particular format. Prompt generator 128 may be used to generate one or more prompts and provide the generated prompts to the ML model. The one or more provided prompts may be used to format the query results summary into a format appropriate for the result summary. In examples, the prompts may include a template that can be used by the machine learning model to format the information.

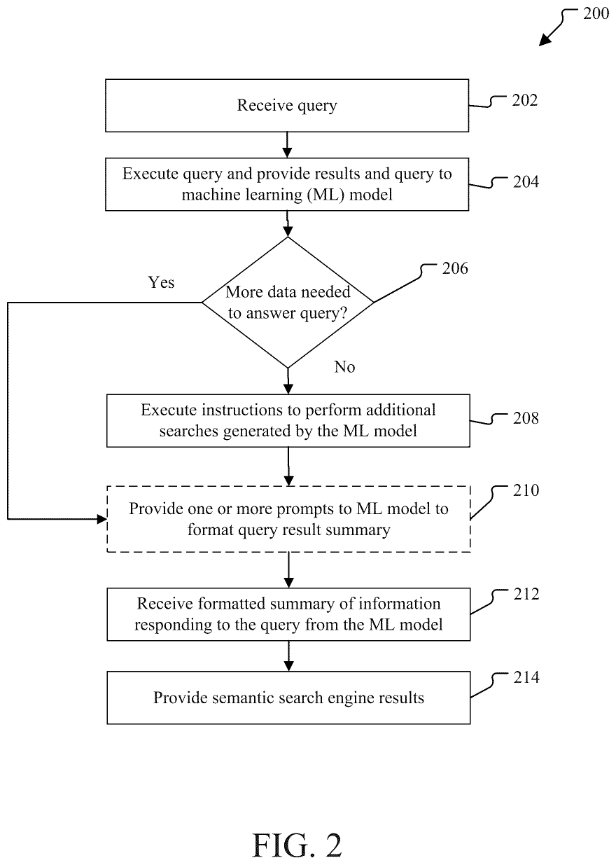

FIG. 2 depicts an exemplary method 200 for generating semantic search engine results. Flow begins at operation 202 where a query is received. In one example, the query may be a query to search for content on the web, such as a query received by a web search engine. For ease of explanation, examples discussed herein are described with respect to a web search query, however, one of skill in the art will appreciate that the aspects disclosed herein may be used to process other types of queries such as, for example, local directory searches, database searches, document repository queries, social media queries, audio and/or visual search queries, etc. In examples, an intent may be derived from the query. For example, the query may be analyzed, using a rule base system, a heuristics algorithm, and/or a machine learning model, to determine an intent or task associated with the suer query. The intent and/or task may be provided in addition to the query at operation 204.

Flow continues to operation 204 where, in examples, the query is executed the results of the query, or a subset of the results (e.g., top result, top ten results, top one hundred results, data from relevant sources (e.g., information from news sources, weather sources, shopping sources, etc.), or other relevant data sources), are provided to a machine learning model along with the received query. For example, the results may be provided to a generative model, such as a generative LLM. In one example, the underlying content of the search result (e.g., web page content, content from a database executing the query, documents, videos, audio files, etc. identified in response to the query, etc.) may be provided to the database. Alternatively, or additionally, rather than providing the entire content (e.g., an entire web page) a summary of the content may be provided. The summarized data related to the content may be previously generated and retrieved from the database. Alternatively, or additionally, the results may be summarized using one or more different machine learning models prior and the generated summaries may be provided to the generative model. In other aspects, one or more different types of generative machine learning models may receive the search results and the query. The type of model receiving the query may be determined based upon the type of results (e.g., content, format, such as image, text, video, etc.).

Flow continues to decision operation 206, where a determination is made as to whether the initial search results are sufficient to respond to the query. For example, the one or more machine learning models that receive the query and the initial query results may determine whether the results answer the query. For example, as previously discussed the query may be analyzed to determine an intent and/or task associated with the query. The intent may be analyzed upon receipt of the query, or may be determined by the generative model at the time of processing the query and results at operation 204. Based upon the determined intent and/or task, the search results may be analyzed to determine whether the intent and/or task associated with the query can be sufficiently addressed. If not, then flow branches “No” to operation 208.

If the initial query results do not sufficiently satisfy the query (e.g., do not adequately satisfy an intent or task associated with the query), the one or more machine learning models may generate additional search queries. The additional queries may be directed towards information not explicitly requested by the query. As an example, the received initial query may be: “Is February a good time to visit Japan.” A machine learning model may determine that the intent of the query is to plan a vacation to Japan in February. While the initial search results, for example, generated by a web search engine, may provide links to articles about Japan in February, the one or more machine learning models may determine to that the intent requires a more comprehensive answer, which could require additional information. In making the determination, the machine learning model may generate additional queries, such as, for example, “Weather in Japan in February,” “Things to do in Japan in February,” “Things to do in Tokyo in February,” “Things to do in Tokyo in February,” “Flights to Japan,” etc. These additional queries may be executed, for example, using a search engine, to generate additional results that that can then be processed by the one or more machine learning models.

At operation 208, the queries for additional information may be executed, for example, by a search engine, file system, database, etc., and the additional search results, and, optionally, the additional queries, may be provided to the one or more machine learning models. The additional information retrieved from these additional queries can be used to provide a comprehensive response to the initial query, thereby satisfying the intent and/or task determined for the initial query without requiring a multi-step process of communication with the user. Flow then continues to operation 210.

Returning briefly to decision operation 206, if the one or more machine learning models determine that the initial set of query results satisfies the intent and/or task determined based upon the query, flow branches Yes to operation 210.

While examples provided herein relate to web search queries, the additional queries are not limited to web searches. For example, the additional queries generated by the one or more machine learning models may be queries to search a local device or datastore for information (in instances where the user has given the one or more ML models permission to search local data stores or may be directed to other data stores (e.g., API calls to query applications, database queries, calls to specific data repositories, such as stock data or weather data, etc.).

At operation 210, one or more prompts may be provided to the ML model. The one or more provided prompts may be used to format the query results summary into a format appropriate for the result summary. In examples, operation 210 may be optional. That is, the one or more prompts to format the results may be provided earlier, for example, with the initial query and set of results, with the additional search results generated at operation 208, etc. In examples, the one or more prompts may be templates that can be used to format or summarize the information generated by one or more generative models. In examples, the templates may be selected based upon the type of data generated by a generative model, based upon a task associated with the query, based upon an intent associated with the query, etc.

Aspects of the present disclosure are operable to utilize a general ML model, that is, a model that is not trained specifically to generate semantic search engine results. For example, a generative large language model may be employed by the method 200. Generally, LLMs are not trained to perform specific tasks. Accordingly, the one or more prompts generated and provided at operation 210 instruct the generative LLM (or other types of generative machine learning models) to generate a summary of the results in a format that is appropriate to the originally received query, and/or appropriate based upon the determined intent and/or task associated with the query.

Flow continues to operation 212, where a summary generated by the one or more machine learning models is received from the one or more machine learning models. While traditional search engines generally return a link of webpages or files that match the search query, aspects of the present disclosure generate a summary that provides a detailed summary of the content related to the query. In examples, the summary of the content is formatted based upon the one or more prompts generated at operation 210. Further, in example, the summary includes citations to the underlying data source (e.g., webpages, documents, video, etc.) for the information included in the summary. The links may be selectable, such that a user may be redirected to the source material by selecting the citation. Alternatively, depending upon the determined intent, a direct answer may be generated. For example, if the query intent relates to specific information, such as a query “What is Abraham Lincoln's Birthday?”, a direct answer may be generated, such that the answer is provided without a summary. In still further aspects, a direct answer and a summary may both be generated and/or provided.

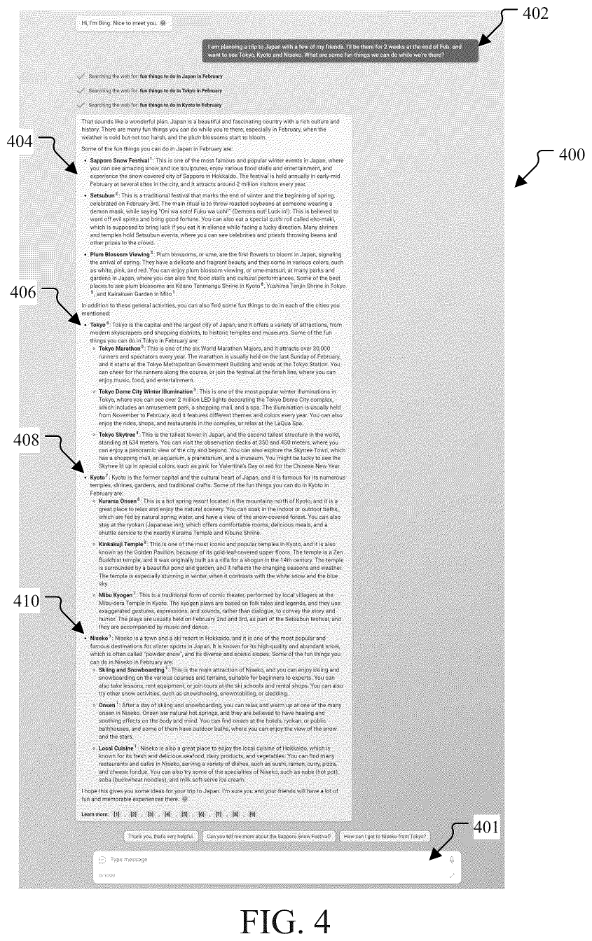

For example, FIG. 4 provides an exemplary user interface 400 depicting a summary of information generated by a sematic search engine. Turning now to FIG. 4, an exemplary user interface 400 is provided, in the form of a chat interface, in which the query 402 about visiting Japan is received. In examples, the query may be received via the text box 401. In alternate user interfaces, not shown in FIG. 4, the query may be received via a different UI component, such as an address bar in an internet browser, via a search engine text box, via audio (e.g., a spoken query, etc. As shown in FIG. 4, the query 402 may be a natural language query. The semantic search engine generates a detailed summary of information about Japan which can be used to answer the user's query. In examples, the detailed summary may be broken into different sections, based upon topic. For example, section 404 details general activities in Japan, section 406 shows things to do in Tokyo, section 408 details things to do in Kyoto, and section 410 details things to do in Niseko. Further, the generative LLM may generate a summary that include references points, which when activated by a user, may direct the user to the source of the information.

While a specific user interface is shown in FIG. 4, alternate user interfaces may be employed, such as a search interface integrated into a browser or webpage, a search interface that is part of an operating system or application, etc. For example, in alternate aspects, the summary of information may be included in a web page that includes traditional search results. For example, a summary of the search results may be included before, in the middle, or after a traditional listing of results generated by a search engine. In still further examples, the summary may be displayed as part of other applications user interface (e.g., within a mobile application, a file browser, and operating system feature, etc.). In still further aspects, although not shown in FIG. 4, the summary may include various types of content in addition to, or instead of, a textual summary. For example, the summary may include images, videos, animations, audio playback, other type of generated resources (e.g., documents, spreadsheets, presentations, etc.) that can be displayed as part of the summary. One of skill in the art will apricate that the summary can be included in a number of different user interfaces that are capable of receiving and displaying the information generated by aspects of the present disclosure.

Returning to FIG. 2, at operation 214, the semantic search engine results are provided. In one example, the results may be provided to an application which received the initial query (e.g., a web browser, a chat interface, etc.). In another example, providing the results may include displaying the results or causing the results to be displayed. In still further examples, the semantic search engine results may be stored for future use. That is, semantic search engine results may be indexed and stored for retrieval upon receiving subsequent queries that are similar or have a similar intent. In doing so, the response time for future queries can be decreased, as the summaries can be retrieved rather than generated in response to the query.

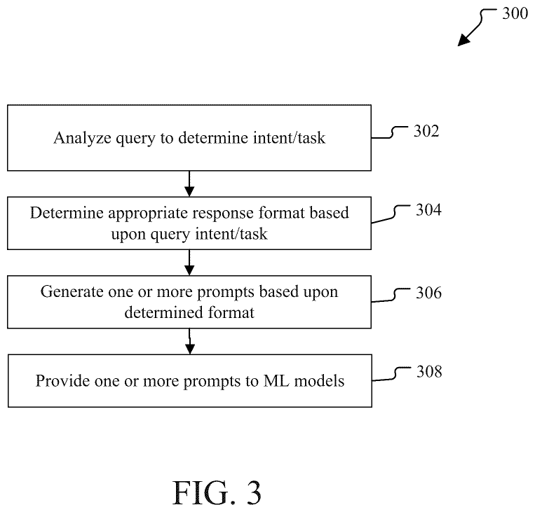

FIG. 3 is a block diagram illustrating a method 300 for generating prompts for a machine learning model that is leveraged by a semantic search engine. Flow begins at operation 302, where a query is analyzed to determine an intent and/or task associated with the query. In one example, a machine learning model may be used to determine an intent or task associated with a query. Alternatively, or additionally, a rules-based process, a query parser, or other type of process may be utilized to determine an intent associated with the application.

Upon determining and intent and/or task for the query, flow continues to operation 304, where a response format is determined. The response format may be based upon a predicted content summary responding to the query. For example, the predicted content type, content length, etc. may be used to determine an appropriate format to best present a response to the query.

At operation 306, one or more prompts may be determined based upon the determined response format. As noted, a generative LLM may be leveraged by a sematic search engine to generate responses to a query. The generative LLM may not be trained to generate the specific type of response, or response format, required to satisfy the query intent and/or task. Rather than fine-tuning the generative LLM, which may be a long and expensive process, one or more prompts may be generated and provided to guide the LLM to produce responses in the desired format. In one example, the one or more prompts may be generated by selecting appropriate pre-defined prompt templates from a prompt data store. In another example, a machine learning model trained to generate prompts may be employed to generate one or more prompts based upon the received query (e.g., the query received at operation 202 of FIG. 2). Upon generating the prompts, flow continues to operation 308 where the one or more prompts are provided to the machine learning model that is leveraged by the semantic search engine.

FIGS. 5A and 5B illustrate overviews of an example generative machine learning model that may be used according to aspects described herein. With reference first to FIG. 5A, conceptual diagram 500 depicts an overview of pre-trained generative model package 504 that processes an input and a prompt 502 to generate model output 506 aspects described herein.

In examples, generative model package 504 is pre-trained according to a variety of inputs (e.g., a variety of human languages, a variety of programming languages, and/or a variety of content types) and therefore need not be finetuned or trained for a specific scenario. Rather, generative model package 504 may be more generally pre-trained, such that input 502 includes a prompt that is generated, selected, or otherwise engineered to induce generative model package 504 to produce certain generative model output 506. It will be appreciated that input 502 and generative model output 506 may each include any of a variety of content types, including, but not limited to, text output, image output, audio output, video output, programmatic output, and/or binary output, among other examples. In examples, input 502 and generative model output 506 may have different content types, as may be the case when generative model package 504 includes a generative multimodal machine learning model.

As such, generative model package 504 may be used in any of a variety of scenarios and, further, a different generative model package may be used in place of generative model package 504 without substantially modifying other associated aspects (e.g., similar to those described herein with respect to FIGS. 1, 2, 3, and 4). Accordingly, generative model package 504 operates as a tool with which machine learning processing is performed, in which certain inputs 502 to generative model package 504 are programmatically generated or otherwise determined, thereby causing generative model package 504 to produce model output 506 that may subsequently be used for further processing.

Generative model package 504 may be provided or otherwise used according to any of a variety of paradigms. For example, generative model package 504 may be used local to a computing device (e.g., computing device 102 in FIG. 1) or may be accessed remotely from a machine learning service (e.g., semantic search engine 120). In other examples, aspects of generative model package 504 are distributed across multiple computing devices. In some instances, generative model package 504 is accessible via an application programming interface (API), as may be provided by an operating system of the computing device and/or by the machine learning service, among other examples.

With reference now to the illustrated aspects of generative model package 504, generative model package 504 includes input tokenization 508, input embedding 510, model layers 512, output layer 514, and output decoding 516. In examples, input tokenization 508 processes input 502 to generate input embedding 510, which includes a sequence of symbol representations that corresponds to input 502. Accordingly, input embedding 510 is processed by model layers 512, output layer 514, and output decoding 516 to produce model output 506. An example architecture corresponding to generative model package 504 is depicted in FIG. 5B, which is discussed below in further detail. Even so, it will be appreciated that the architectures that are illustrated and described herein are not to be taken in a limiting sense and, in other examples, any of a variety of other architectures may be used.

FIG. 5B is a conceptual diagram that depicts an example architecture 550 of a pre-trained generative machine learning model that may be used according to aspects described herein. As noted above, any of a variety of alternative architectures and corresponding ML models may be used in other examples without departing from the aspects described herein.

As illustrated, architecture 550 processes input 502 to produce generative model output 506, aspects of which were discussed above with respect to FIG. 5A. Architecture 550 is depicted as a transformer model that includes encoder 552 and decoder 554. Encoder 552 processes input embedding 558 (aspects of which may be similar to input embedding 510 in FIG. 5A), which includes a sequence of symbol representations that corresponds to input 556. In examples, input 556 includes input and prompt for generation 502 (e.g., corresponding to a skill of a skill chain).

Further, positional encoding 560 may introduce information about the relative and/or absolute position for tokens of input embedding 558. Similarly, output embedding 574 includes a sequence of symbol representations that correspond to output 572, while positional encoding 576 may similarly introduce information about the relative and/or absolute position for tokens of output embedding 574.

As illustrated, encoder 552 includes example layer 570. It will be appreciated that any number of such layers may be used, and that the depicted architecture is simplified for illustrative purposes. Example layer 570 includes two sub-layers: multi-head attention layer 562 and feed forward layer 566. In examples, a residual connection is included around each layer 562, 566, after which normalization layers 564 and 568, respectively, are included.

Decoder 554 includes example layer 590. Similar to encoder 552, any number of such layers may be used in other examples, and the depicted architecture of decoder 554 is simplified for illustrative purposes. As illustrated, example layer 590 includes three sub-layers: masked multi-head attention layer 578, multi-head attention layer 582, and feed forward layer 586. Aspects of multi-head attention layer 582 and feed forward layer 586 may be similar to those discussed above with respect to multi-head attention layer 562 and feed forward layer 566, respectively. Additionally, masked multi-head attention layer 578 performs multi-head attention over the output of encoder 552 (e.g., output 572). In examples, masked multi-head attention layer 578 prevents positions from attending to subsequent positions. Such masking, combined with offsetting the embeddings (e.g., by one position, as illustrated by multi-head attention layer 582), may ensure that a prediction for a given position depends on known output for one or more positions that are less than the given position. As illustrated, residual connections are also included around layers 578, 582, and 586, after which normalization layers 580, 584, and 588, respectively, are included.

Multi-head attention layers 562, 578, and 582 may each linearly project queries, keys, and values using a set of linear projections to a corresponding dimension. Each linear projection may be processed using an attention function (e.g., dot-product or additive attention), thereby yielding n-dimensional output values for each linear projection. The resulting values may be concatenated and once again projected, such that the values are subsequently processed as illustrated in FIG. 5B (e.g., by a corresponding normalization layer 564, 580, or 584).

Feed forward layers 566 and 586 may each be a fully connected feed-forward network, which applies to each position. In examples, feed forward layers 566 and 586 each include a plurality of linear transformations with a rectified linear unit activation in between. In examples, each linear transformation is the same across different positions, while different parameters may be used as compared to other linear transformations of the feed-forward network.

Additionally, aspects of linear transformation 592 may be similar to the linear transformations discussed above with respect to multi-head attention layers 562, 578, and 582, as well as feed forward layers 566 and 586. Softmax 594 may further convert the output of linear transformation 592 to predicted next-token probabilities, as indicated by output probabilities 596. It will be appreciated that the illustrated architecture is provided in as an example and, in other examples, any of a variety of other model architectures may be used in accordance with the disclosed aspects.

Accordingly, output probabilities 596 may thus form model output 506 according to aspects described herein, such that the output of the generative ML model defines an output corresponding to the input. For instance, model output 506 may be associated with a corresponding application and/or data format, such that model output is processed to display the semantic search engine page, among other examples.

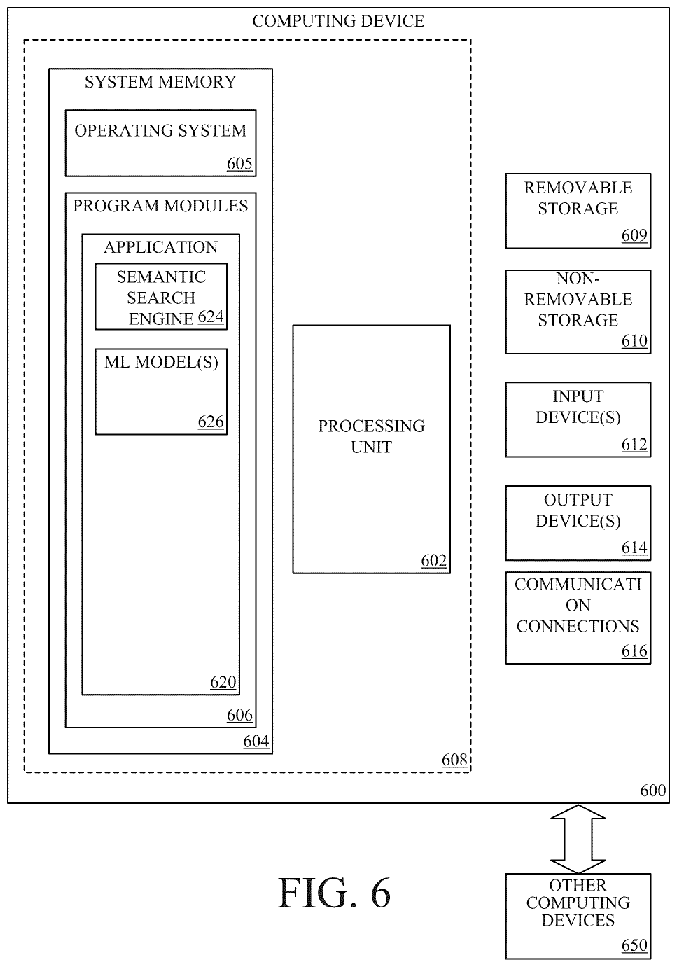

FIGS. 6-8 and the associated descriptions provide a discussion of a variety of operating environments in which aspects of the disclosure may be practiced. However, the devices and systems illustrated and discussed with respect to FIGS. 6-8 are for purposes of example and illustration and are not limiting of a vast number of computing device configurations that may be utilized for practicing aspects of the disclosure, described herein.

FIG. 6 is a block diagram illustrating physical components (e.g., hardware) of a computing device 600 with which aspects of the disclosure may be practiced. The computing device components described below may be suitable for the computing devices described above, including computing device 102 in FIG. 1. In a basic configuration, the computing device 600 may include at least one processing unit 602 and a system memory 604. Depending on the configuration and type of computing device, the system memory 604 may comprise, but is not limited to, volatile storage (e.g., random access memory), non-volatile storage (e.g., read-only memory), flash memory, or any combination of such memories.

The system memory 604 may include an operating system 605 and one or more program modules 606 suitable for running software application 620, such as one or more components supported by the systems described herein. As examples, system memory 604 may store semantic search engine 624 and/or machine learning model(s) 626. The operating system 605, for example, may be suitable for controlling the operation of the computing device 600.

Furthermore, aspects of the disclosure may be practiced in conjunction with a graphics library, other operating systems, or any other application program and is not limited to any particular application or system. This basic configuration is illustrated in FIG. 6 by those components within a dashed line 608. The computing device 600 may have additional features or functionality. For example, the computing device 600 may also include additional data storage devices (removable and/or non-removable) such as, for example, magnetic disks, optical disks, or tape. Such additional storage is illustrated in FIG. 6 by a removable storage device 609 and a non-removable storage device 610.

As stated above, a number of program modules and data files may be stored in the system memory 604. While executing on the processing unit 602, the program modules 606 (e.g., application 620) may perform processes including, but not limited to, the aspects, as described herein. Other program modules that may be used in accordance with aspects of the present disclosure may include electronic mail and contacts applications, word processing applications, spreadsheet applications, database applications, slide presentation applications, drawing or computer-aided application programs, etc.

Furthermore, aspects of the disclosure may be practiced in an electrical circuit comprising discrete electronic elements, packaged or integrated electronic chips containing logic gates, a circuit utilizing a microprocessor, or on a single chip containing electronic elements or microprocessors. For example, aspects of the disclosure may be practiced via a system-on-a-chip (SOC) where each or many of the components illustrated in FIG. 6 may be integrated onto a single integrated circuit. Such an SOC device may include one or more processing units, graphics units, communications units, system virtualization units and various application functionality all of which are integrated (or “burned”) onto the chip substrate as a single integrated circuit. When operating via an SOC, the functionality, described herein, with respect to the capability of client to switch protocols may be operated via application-specific logic integrated with other components of the computing device 600 on the single integrated circuit (chip). Some aspects of the disclosure may also be practiced using other technologies capable of performing logical operations such as, for example, AND, OR, and NOT, including but not limited to mechanical, optical, fluidic, and quantum technologies. In addition, some aspects of the disclosure may be practiced within a general purpose computer or in any other circuits or systems.

The computing device 600 may also have one or more input device(s) 612 such as a keyboard, a mouse, a pen, a sound or voice input device, a touch or swipe input device, etc. The output device(s) 614 such as a display, speakers, a printer, etc. may also be included. The aforementioned devices are examples and others may be used. The computing device 600 may include one or more communication connections 616 allowing communications with other computing devices 650. Examples of suitable communication connections 616 include, but are not limited to, radio frequency (RF) transmitter, receiver, and/or transceiver circuitry; universal serial bus (USB), parallel, and/or serial ports.

The term computer readable media as used herein may include computer storage media. Computer storage media may include volatile and nonvolatile, removable and non-removable media implemented in any method or technology for storage of information, such as computer readable instructions, data structures, or program modules. The system memory 604, the removable storage device 609, and the non-removable storage device 610 are all computer storage media examples (e.g., memory storage). Computer storage media may include RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other article of manufacture which can be used to store information and which can be accessed by the computing device 600. Any such computer storage media may be part of the computing device 600. Computer storage media does not include a carrier wave or other propagated or modulated data signal.

Communication media may be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media.

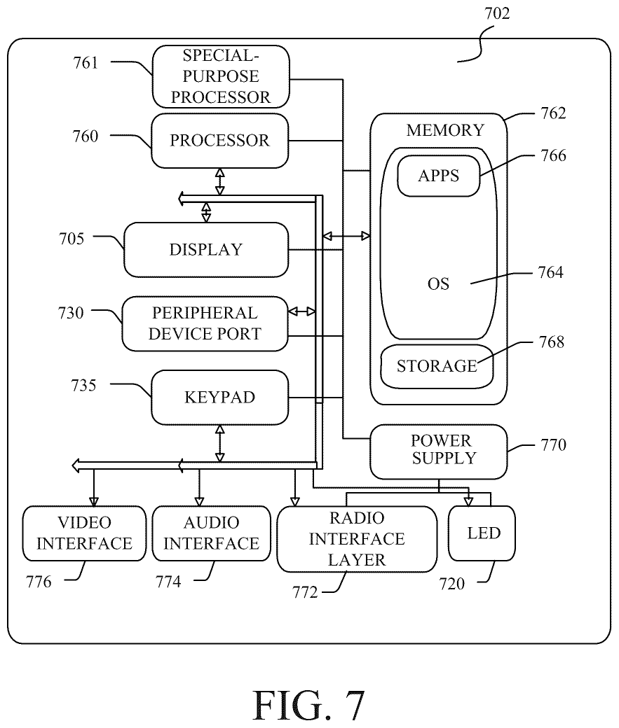

FIG. 7 is a block diagram illustrating the architecture of one aspect of a computing device. That is, the computing device can incorporate a system (e.g., an architecture) 702 to implement some aspects. In some examples, the system 702 is implemented as a “smart phone” capable of running one or more applications (e.g., browser, e-mail, calendaring, contact managers, messaging clients, games, and media clients/players). In some aspects, the system 702 is integrated as a computing device, such as an integrated personal digital assistant (PDA) and wireless phone.

One or more application programs 766 may be loaded into the memory 762 and run on or in association with the operating system 764. Examples of the application programs include phone dialer programs, e-mail programs, personal information management (PIM) programs, word processing programs, spreadsheet programs, Internet browser programs, messaging programs, and so forth. The system 702 also includes a non-volatile storage area 768 within the memory 762. The non-volatile storage area 768 may be used to store persistent information that should not be lost if the system 702 is powered down. The application programs 766 may use and store information in the non-volatile storage area 768, such as e-mail or other messages used by an e-mail application, and the like. A synchronization application (not shown) also resides on the system 702 and is programmed to interact with a corresponding synchronization application resident on a host computer to keep the information stored in the non-volatile storage area 768 synchronized with corresponding information stored at the host computer. As should be appreciated, other applications may be loaded into the memory 762 and run on the mobile computing device 700 described herein (e.g., an embedding object memory insertion engine, an embedding object memory retrieval engine, etc.).

The system 702 has a power supply 770, which may be implemented as one or more batteries. The power supply 770 might further include an external power source, such as an AC adapter or a powered docking cradle that supplements or recharges the batteries.

The system 702 may also include a radio interface layer 772 that performs the function of transmitting and receiving radio frequency communications. The radio interface layer 772 facilitates wireless connectivity between the system 702 and the “outside world,” via a communications carrier or service provider. Transmissions to and from the radio interface layer 772 are conducted under control of the operating system 764. In other words, communications received by the radio interface layer 772 may be disseminated to the application programs 766 via the operating system 764, and vice versa.

The visual indicator 720 may be used to provide visual notifications, and/or an audio interface 774 may be used for producing audible notifications via the audio transducer 725. In the illustrated example, the visual indicator 720 is a light emitting diode (LED) and the audio transducer 725 is a speaker. These devices may be directly coupled to the power supply 770 so that when activated, they remain on for a duration dictated by the notification mechanism even though the processor 760 and/or special-purpose processor 761 and other components might shut down for conserving battery power. The LED may be programmed to remain on indefinitely until the user takes action to indicate the powered-on status of the device. The audio interface 774 is used to provide audible signals to and receive audible signals from the user. For example, in addition to being coupled to the audio transducer 725, the audio interface 774 may also be coupled to a microphone to receive audible input, such as to facilitate a telephone conversation. In accordance with aspects of the present disclosure, the microphone may also serve as an audio sensor to facilitate control of notifications, as will be described below. The system 702 may further include a video interface 776 that enables an operation of an on-board camera 730 to record still images, video stream, and the like.

A computing device implementing the system 702 may have additional features or functionality. For example, the computing device may also include additional data storage devices (removable and/or non-removable) such as, magnetic disks, optical disks, or tape. Such additional storage is illustrated in FIG. 7 by the non-volatile storage area 768.

Data/information generated or captured by the computing device and stored via the system 702 may be stored locally on the computing device, as described above, or the data may be stored on any number of storage media that may be accessed by the device via the radio interface layer 772 or via a wired connection between the computing device and a separate computing device associated with the computing device, for example, a server computer in a distributed computing network, such as the Internet. As should be appreciated such data/information may be accessed via the computing device via the radio interface layer 772 or via a distributed computing network. Similarly, such data/information may be readily transferred between computing devices for storage and use according to well-known data/information transfer and storage means, including electronic mail and collaborative data/information sharing systems.

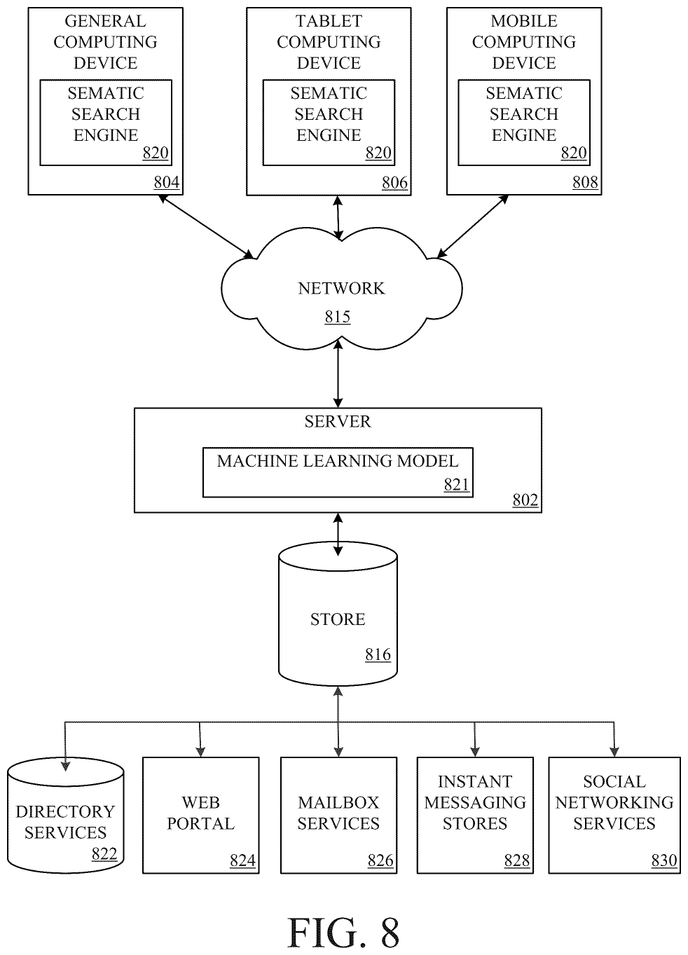

FIG. 8 illustrates one aspect of the architecture of a system for processing data received at a computing system from a remote source, such as a personal computer 804, tablet computing device 806, or mobile computing device 808, as described above. Content displayed at server device 802 may be stored in different communication channels or other storage types. For example, various documents may be stored using a directory service 824, a web portal 825, a mailbox service 826, an instant messaging store 828, or a social networking site 830.

An application 820 (e.g., similar to the application 620) may be employed by a client that communicates with server device 802. Additionally, or alternatively, machine learning models 821 may be employed by server device 802. The server device 802 may provide data to and from a client computing device such as a personal computer 804, a tablet computing device 806 and/or a mobile computing device 808 (e.g., a smart phone) through a network 815. By way of example, the computer system described above may be embodied in a personal computer 804, a tablet computing device 806 and/or a mobile computing device 808 (e.g., a smart phone). Any of these examples of the computing devices may obtain content from the store 816, in addition to receiving graphical data useable to be either pre-processed at a graphic-originating system, or post-processed at a receiving computing system.

In one example, aspects of the present disclosure relate to a system comprising: at least one processor; and memory storing instructions that, when executed by the at least one processor, cause the system to perform a set of operations, the set of operations comprising: receive a query; generate an initial set of query results; provide the query and initial set of query results to a generative large language model; receive at least one additional query from the generative large language model; execute the at least one additional query; provide the results from the at least one additional query to the generative large language model; receive semantic search engine results from the generative large language model; and provide the semantic search engine results.

In yet another example, the system further comprises instruction to generate one or more alternate queries based upon the query, and wherein generating the initial set of query results comprised generating alternate query results based upon the one or more additional queries.

In still another example, the semantic search engine results are included in a summary generated by the generative large language model.

In another example, a format for the summary is determined based upon a type of information included in the summary.

In yet another example, a format for the summary is determined based upon a template provided to the generative large language model.

In still further examples, the summary includes one or more citations, and wherein the one or more citations link to one or more underlying data sources for the summary.

In further examples, the system comprises, determining an intent or a task based upon the received query, wherein the intent or the task is provided to the generative large language model.

In still further examples, the system further comprises operations to determine, using the generative large language model, whether additional information is required, wherein the determination is based upon the intent or task.

In yet further examples, the at least one additional query is generated by the generative large language model when it is determined that an additional information is required.

In another example, aspects of the disclosure relate to a method for generating semantic search engine results, the method comprising: receiving a query; generating an initial set of query results; providing the query and initial set of query results to a generative model; determining, using the generative model, that additional information is needed; receiving at least one additional query from the generative model; execute the at least one additional query; provide the results from the at least one additional query to the generative large language model; receive semantic search engine results from the generative model; and provide the semantic search engine results.

In examples, the method further comprises analyzing the query to determine an intent or a task based upon the query, wherein analyzing the query comprises providing the query to at least one of the generative model or an alternate machine learning model.

In yet another example, the method further comprises determining a format for the semantic search engine results, wherein the format is determined based upon the query or the task.

In further examples, the method further comprises generating a prompt for the generative model, wherein the prompt is generated based upon the format.

In still further examples the prompt comprises a template associated with the format, wherein the template defines the format for the semantic search engine results.

In another example, the generative model is a generative large language model.

In still another example, the semantic search engine results are included in a summary generated by the generative large language model, and wherein the summary includes one or more citations, and wherein the one or more citations link to one or more underlying data sources for the summary.

In still further aspects, aspects of the present discloser relate to computer storage medium comprising computer-executable instructions that, when executed by at least one processing unit, performs a method for generating semantic search engine results, the method comprising: receiving a query; generating an initial set of query results; providing the query and initial set of query results to a generative large language model; determining, using the generative model, that additional information is needed; receiving at least one additional query from the generative large language model; execute the at least one additional query; provide the results from the at least one additional query to the generative large language model; receive semantic search engine results from the generative large language model; and provide the semantic search engine results.

In examples, the method further comprises: analyzing the query to determine an intent or a task based upon the query, wherein analyzing the query comprises providing the query to at least one of the generative model or an alternate machine learning model; and determining a format for the semantic search engine results, wherein the format is determined based upon the query or the task.

In yet another example, the method further comprises generating a prompt for the generative model, wherein the prompt is generated based upon the format.

In still further examples, the semantic search engine results are included in a summary generated by the generative large language model, and wherein the summary includes one or more citations, and wherein the one or more citations link to one or more underlying data sources for the summary.

Aspects of the present disclosure, for example, are described above with reference to block diagrams and/or operational illustrations of methods, systems, and computer program products according to aspects of the disclosure. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

The description and illustration of one or more aspects provided in this application are not intended to limit or restrict the scope of the disclosure as claimed in any way. The aspects, examples, and details provided in this application are considered sufficient to convey possession and enable others to make and use claimed aspects of the disclosure. The claimed disclosure should not be construed as being limited to any aspect, example, or detail provided in this application. Regardless of whether shown and described in combination or separately, the various features (both structural and methodological) are intended to be selectively included or omitted to produce an embodiment with a particular set of features. Having been provided with the description and illustration of the present application, one skilled in the art may envision variations, modifications, and alternate aspects falling within the spirit of the broader aspects of the general inventive concept embodied in this application that do not depart from the broader scope of the claimed disclosure.

What is claimed is:

1. A system comprising:
at least one processor; and
memory storing instructions that, when executed by the at least one processor, cause the system to perform a set of operations, the set of operations comprising:
receive a query;
generate an initial set of query results;
provide the query and initial set of query results to a generative large language model;
receive at least one additional query from the generative large language model;
execute the at least one additional query;
provide the results from the at least one additional query to the generative large language model;
receive semantic search engine results from the generative large language model; and
provide the semantic search engine results.

2. The system of claim 1, further comprising instruction to generate one or more alternate queries based upon the query, and wherein generating the initial set of query results comprised generating alternate query results based upon the one or more additional queries.

3. The system of claim 1, wherein the semantic search engine results are included in a summary generated by the generative large language model.

4. The system of claim 3, wherein a format for the summary is determined based upon a type of information included in the summary.

5. The system of claim 3, wherein a format for the summary is determined based upon a template provided to the generative large language model.

6. The system of claim 1, wherein the summary includes one or more citations, and wherein the one or more citations link to one or more underlying data sources for the summary.

7. The system of claim 1, further comprising, determining an intent or a task based upon the received query, wherein the intent or the task is provided to the generative large language model.

8. The system of claim 7, further comprising operations to determine, using the generative large language model, whether additional information is required, wherein the determination is based upon the intent or task.

9. The system of claim 7, wherein the at least one additional query is generated by the generative large language model when it is determined that an additional information is required.

10. A method for generating semantic search engine results, the method comprising:
receiving a query;
generating an initial set of query results;
providing the query and initial set of query results to a generative model;
determining, using the generative model, that additional information is needed;
receiving at least one additional query from the generative model;
execute the at least one additional query;
provide the results from the at least one additional query to the generative large language model;
receive semantic search engine results from the generative model; and
provide the semantic search engine results.

11. The method of claim 10, further comprising analyzing the query to determine an intent or a task based upon the query, wherein analyzing the query comprises providing the query to at least one of the generative model or an alternate machine learning model.

12. The method of claim 11, further comprising determining a format for the semantic search engine results, wherein the format is determined based upon the query or the task.

13. The method of claim 12, further comprising generating a prompt for the generative model, wherein the prompt is generated based upon the format.

14. The method of claim 13, wherein the prompt comprises a template associated with the format, wherein the template defines the format for the semantic search engine results.

15. The method of claim 10, wherein the generative model is a generative large language model.

16. The method of claim 10, wherein the semantic search engine results are included in a summary generated by the generative large language model, and wherein the summary includes one or more citations, and wherein the one or more citations link to one or more underlying data sources for the summary.

17. A computer storage medium comprising computer-executable instructions that, when executed by at least one processing unit, performs a method for generating semantic search engine results, the method comprising:
receiving a query;
generating an initial set of query results;
providing the query and initial set of query results to a generative large language model;
determining, using the generative model, that additional information is needed;
receiving at least one additional query from the generative large language model;
execute the at least one additional query;
provide the results from the at least one additional query to the generative large language model;
receive semantic search engine results from the generative large language model; and
provide the semantic search engine results.

18. The computer storage medium of claim 17, wherein the method further comprises:
analyzing the query to determine an intent or a task based upon the query, wherein analyzing the query comprises providing the query to at least one of the generative model or an alternate machine learning model; and
determining a format for the semantic search engine results, wherein the format is determined based upon the query or the task.

19. The computer storage medium of claim 18, wherein the method further comprises generating a prompt for the generative model, wherein the prompt is generated based upon the format.

20. The computer storage medium of claim 17, wherein the semantic search engine results are included in a summary generated by the generative large language model, and wherein the summary includes one or more citations, and wherein the one or more citations link to one or more underlying data sources for the summary.
